(19) United States
(12) Patent Application Publication
(10) Pub. No.: US 2016/0179154 A1
(43) Pub. Date: Jun. 23, 2016

(54) CONTROLLING THE OPERATING STATE OF A SYSTEM BASED ON THE OPERATING STATE OF A CONNECTED PERIPHERAL OR SYSTEM

(71) Applicant: WEN-HSIEN LAI, Taoyuan Hsien (TW)

(72) Inventor: WEN-HSIEN LAI, Taoyuan Hsien (TW)

(73) Assignee: IN WIN DEVELOPMENT, INC., Taoyuan Hsien (TW)

(21) Appl. No.: 14/578,160

(22) Filed: Dec. 19, 2014

(51) Int. Cl. G06F 1/26

(52) U.S. Cl. CPC G06F 1/263; G06F 1/266

(57) ABSTRACT

The present invention discloses controlling the operating state of a system based on the operating state of a connected peripheral or system, in which a powered device module (PD module) is installed in a general computer system, and via power source equipment (PSE) supply power to a PD module, via connected device (CD) Control the synchronous power of the PD module to detect and control turning on and turning off the power supply.

### BACKGROUND OF THE INVENTION

(a) Field of the Invention

The present invention relates to detecting the power state of a connected peripheral or system and adjusting the power state of a mutually connected and independent system to allow the power state and the operation of the two independent systems to function in unison. The invention provides an independent and mutually connected common power supply system, which synchronously turns or and turns off a power supply for normal operation.

(b) Description of the Prior Art

No.

### SUMMARY OF THE INVENTION

The primary object of the present invention provides a method to control the power state, and therefore operating state of a computer that contains a powered device module (PD module) installed in a computer system. The PD module receives power from the connected power source equipment (PSE). The PD module converts the PSE power to a suitable voltage source to power a connected peripheral or a computer system and the connected device (CD). The PD module may convert the PSE voltage source to an AC voltage source or a DC voltage source depending on the requirements of the CD. The voltage source to the CD is provided uninterrupted upon presence of the PSE voltage. The PD module also provides an uninterrupted voltage source for the computer system that contains the PD module. The invention monitors the power consumption of the CD and uses the power consumption of the CD for detecting the operational state of the CD. The invention then controls the operational state of the computer housing the PD module to match the operational state required by the CD to allow the CD and system to function like they had a single power control.

To enable a further understanding of the said objectives and the technological methods of the invention herein, the brief description of the drawing below is followed by the detailed description of the preferred embodiments.

### BRIEF DESCRIPTION OF THE DRAWINGS

FIG. 1 shows a block diagram of the present invention.

### DETAILED DESCRIPTION OF THE PREFERRED EMBODIMENTS

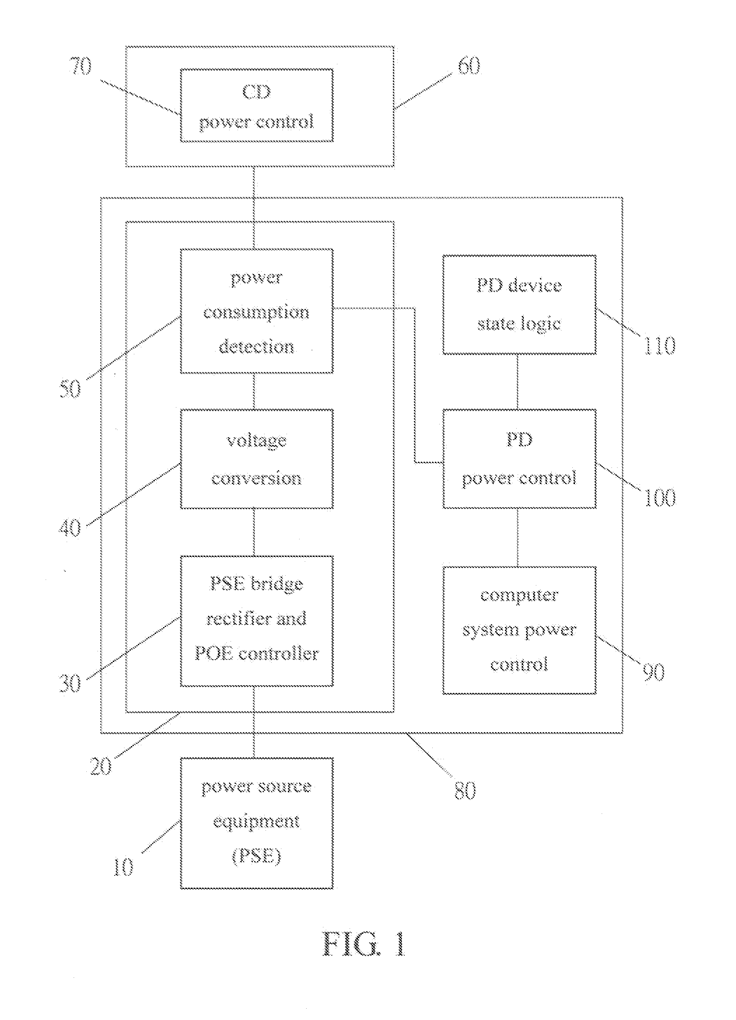

Referring to FIG. 1, a power source equipment (PSE) 10 is connected to a powered device module (PD module) 20 that is integral to the computer system 80. A connected device (CD) 60 connects to the PD module 20. The PSE 10 provides a power source to the PD module 20. The PD module 20 then provides a power source to the computer system 80 and the connected device 60. The power from PSE 10 is provided uninterrupted to the PD module 20, the PD module 20 then converts the power from the PSE 10 to the required power characteristics for the computer system 80 and the connected device 60. The power characteristics of the computer system 80 and connected device 60 can be the same or they can be different. The PD module 20 is also connected to the power control of the computer system 80 to allow the PD module 20 to control the operational power state of the computer system 80. The amount of power flowing to the connected device (CD) 60 is monitored by the PD module 20. The PD power control 100 circuit is triggered by the occurrence of specific power consumption to indicate an operational state of the CD 60. For example, any current below the level of 2 W power consumption means that the CD 60 is in a shutdown state (OFF) or the sleep state (SLEEP); when any current level is higher than the power consumption of 2 W, which means the CD 60 is in an operating state (ON).

Furthermore, as shown in FIG. 1 the operating of the computer system power control 90 is based on the power consumption of the CD 60 and the operational state of the computer system 80. Examining FIG. 1 the PSE 10 provides the power to the PD module 20 which is integral to the computer system 80. The PSE bridge rectifier and power over ethernet (POE) controller 30 and the converted into a suitable voltage type and voltage level for the CD 60 and the computer system 80. The voltage type and level maybe different for the CD 60 and computer system 80. When a user activates the CD power control (i.e: power button) 70 by activating a power button or software controlled operation, the operational state of the CD 60 is measured by measuring power consumption detection 50 at the connection to the CD 60. If the power consumption detection 50 measured indicates the CD 60 is in the ON state the PD power control 100 is activated. The action of the PD power control 100 is conditioned by the PD device state logic 110. The PD device state logic 110 provides the PD power control 100 with the operational state of the computer system 80. The operation of the PD power control 100 can be modified by the state of the computer system 80 to prevent invalid power activation. The computer system power control (i.e: power button or software control) 90 can operate the computer system 80 independently of the PD power control 100.

The present invention utilizes the PD device state logic 110 as detailed in Table 1 and portions of which are described below for clarity:
1. If the power consumption is above 2 W, AND the computer system 80 state is “OFF”→power switch (PWR ON) signal lines are activated to turn on the computer system 80.
2. If the power consumption is above 2 W, AND the system status is “SLEEP”→power switch (PWR ON) signal lines are activated to turn on the computer system 80.
3. If the power consumption is above 2 W, AND the system status is “ON” →power switch (PWR ON) signal line are not activated, resulting in no change in the computer system 80 state.
4. If the power consumption is below 2 W, AND the system status is “OFF” →power switch (PWR ON) signal line is not activated, resulting in no change in the computer system 80 state.
5. If the power consumption is below 2 W, AND system status is “SLEEP” →power switch (PWR ON) signal system is not activated, resulting in no change in the computer system 80 state.
6. If the power consumption is below 2 W, AND the system status is “ON” →power switch (PWR ON) signal line is not activated, resulting in no change in the computer system 80 state.

When a connected device (CD) 60 is in an “ON” state, the current consumption is greater than when in an “OFF” state. The “OFF” state is not based on the operational states having an absence of current consumption, but the power consumption is less than when in an “ON” state, or below the power level of energy standard specifications.

Referring to Table 1, the table summarizes the alternating states of the computer system 80 between the PSE 10 and the connected device 60. From the Table 1 it can be understood whether the power supply is in an “ON” state, “SLEEP” state, “WAKE UP” state, or an “OFF” state by monitoring the power supply status and operating circumstances.

In conclusion, according to the above description of the embodiments of the present invention, a PD Module is provided with an independent and mutually connected common power supply system, which is able to synchronously turn on or turn off power supply to enable the system to function normally.

It is to be understood that the above description and drawings are only used for illustrating some embodiments of the present invention, not intended to limit the scope thereof. Any variation and deviation from the above description and drawings should be included in the scope of the present invention.

TABLE 1

| Actions | Action Trigger | Power Consumption | System | Sleep | Action |
|---|---|---|---|---|---|
| Turn On | Connected device | Increases | 0 | 0 | Activate switch to power system on |
| | button | | | | |
| System Sleep | System | Decreases | 0 | 1 | Do nothing. Connected device may |
| | | | | | go into low power state |
| | | | | | automatically |
| System Sleep | Connected device | Decreases | 1 | 0 | Do nothing to system. Monitor sleep |
| | button | | | | |
| System Wake | System | Increases | 1 | 0 | Do nothing |
| System Wake | Connected device | Increases | 0 | 1 | Activate switch to wake system |
| | button | | | | |
| Monitor Sleep | System | Decreases | 1 | 0 | Do nothing |
| Monitor Sleep | Connected device | Decreases | 1 | 0 | Do nothing |
| | button | | | | |
| Monitor Wake | System | Increases | 1 | 0 | Do nothing |
| Monitor Wake | Connected device | Increases | 1 | 0 | Do nothing |
| | button | | | | |
| System Off | System | Decreases | 0 | 0 | Do nothing |

1. A controlling the operating state of a system based on the operating state of a connected peripheral or system, wherein a powered device module (PD module) is installed in a computer system, and a power source equipment (PSE) supply power the PD module.

2. The controlling the operating state of a system based on the operating state of a connected peripheral or system according to claim 1, wherein the interior of the PD module comprises an AC outlet, an AC current sense, a DC to AC conversion, a PD device state logic and a PD power control.
